(19) United States
(12) Patent Application Publication
(10) Pub. No.: US 2012/0256423 A1
(43) Pub. Date: Oct. 11, 2012

(54) DEVICE OF FLOATING WIND TURBINE CAPABLE OF COUNTERBALANCING TORQUES THEREIN

(76) Inventor: KUO-SHEN LIU, Taipei (TW)

(21) Appl. No.: 13/081,460

(22) Filed: Apr. 6, 2011

(51) Int. Cl. F03D 9/00

(52) U.S. Cl. 290/55

(57) ABSTRACT

A device of floating wind turbines comprises a floating foundation, the wind turbine mounted on the floating foundation, and a seabed anchor attached to the floating foundation, wherein the floating foundation is installed with two wind turbines and is attached to the seabed anchor by a tether, the two wind turbines are configured such that one of the two wind turbines has blades rotated in clockwise direction while the other of the two wind turbines has blades rotated in counter-clockwise direction, both turbines have an approximately equal speed and output power; whereby, due to both turbines having an approximately equal speed and output power, the torques existed in the wind turbines can be naturally counterbalanced, such that the wind turbines and the floating foundation can be maintained at a balance.

### (a) TECHNICAL FIELD OF THE INVENTION

The present invention relates to a device of floating wind turbine capable of counterbalancing torques therein and, more particularly, to a device of floating wind generator capable of counterbalancing torques therein, based on two wind turbines each provided with blades respectively rotated in clockwise direction and counter-clockwise direction, and due to both turbines having an approximately equal speed and output power, the torques existed in the two wind turbines are naturally counterbalanced and thus the turbines and the floating foundation can be maintained at a balanced condition.

### (b) DESCRIPTION OF THE PRIOR ART

Since the wind power energy is the cheapest renewable energy for the moment of facing the imminent depletion of fossil-fuel energy, every country strived to develop the wind power technology in these years. Due to the high cost of land and the fact that the wind is stronger and steadier on the sea, wind turbines are gradually installed in offshore area. However, if the water depth is more than 35 m, it will be more difficult to install a wind turbine. Thus, most of wind turbines are installed in nearshore area for the time being. The coverage and the strength of wind flow in nearshore area are of course less than those of an offshore area. Suppose an offshore wind turbine is desired to be installed in areas having water depths more than 35 m, the most simple way is as shown in FIG. 1, in which a wind turbine 10 is mounted on a floating foundation 11, a ballast 12 is employed to keep balance between the front and the rear of the foundation, the floating foundation 11 is attached to an anchor 15 fixed on the seabed 14 by tethers or ropes 13, and further, the floating foundation 11 is provided with a vane 16 in stead of a yawing device to enable the floating foundation 11 to drift in the sea along the wind direction 17, so that the blades 19 of the wind turbine 10 can be kept in line with the wind direction. This method appears to be simple and economical. It is believed that lots of people want to do so. However, there is a problem making it infeasible. As shown in FIG. 2, when the blades 19 are rotated to generate power, the wind turbine 10 will have an electromagnetic force to snap the rotating shaft, which in turn converts the rotary kinetic energy to the electrical power. As a result, the torque of the blades 19 will act on the stator of the wind turbine 10, the tower and the floating foundation 11, thereby to cause the floating foundation 11 tilted or even tumbled, as shown in FIG. 2. So far, the problem is not solved. A number of patents such as U.S. Pat. Nos. 7,612,462, 7,156,586, 7,819,073, D0567176 cannot solve the problem. Thus, there is no such a wind turbine of the type available up to now.

In view of the foregoing, according to the long-term experiences of wind turbines and after continuous efforts in the research and experiment, the applicant has contrived a way to solve the above problem, by which torques of turbines can be naturally counterbalanced, so that the wind turbines and the floating foundation can be maintained at a balanced condition.

### SUMMARY OF THE INVENTION

The primary object is to provide a device of floating wind turbine capable of counterbalancing torques therein, in which two wind turbines are provided with blades respectively rotated in clockwise direction and counter-clockwise direction. Due to both turbines having an approximately equal speed and output power, the torques existed in the two wind turbines are naturally counterbalanced and thus the turbines and the floating foundation can maintain a balance.

The aforementioned device comprises a floating foundation, wind turbines mounted on the floating foundation, and a seabed anchor attached to the floating foundation, wherein the floating foundation is provided with two wind turbines and secured to a seabed anchor by a tether, the two wind turbines are configured such that one of the two wind turbines has blades rotated in clockwise direction while the other rotated in counter-clockwise direction. Due to both turbines having an approximately equal speed and output power, the torques existed in the two wind turbine can be naturally counterbalanced, such that the wind turbines and the floating foundation can be maintained at a balanced condition.

In the aforementioned device, the two wind turbines each can be a horizontal-axis wind turbine (HAWT) or vertical-axis wind turbine (VAWT). Alternatively, the two wind turbines each can be an upwind design (the turbine blades placed in front of the nacelle) or a downwind design (the turbine blades placed at the rear of the nacelle). Alternatively, one of the two wind turbines can be an upwind design while the other of the wind turbines is a downwind design.

Furthermore, in the aforementioned device, the wind turbines are each provided with blades of fixed or variable pitch (for variable pitch blade, its angle can be changed via a control).

Furthermore, in the aforementioned device, an even number and more than two of wind turbines can be mounted on the floating station so that one half of the wind turbines each has blades rotated in clockwise direction, the other half of the wind turbines s each rotated in counter-clockwise direction. In such arrangement, torques existed in the wind turbines can be counterbalanced in a similar way.

### BRIEF DESCRIPTION OF THE DRAWINGS

FIG. 1 is a 3-dimensional view showing a construction of a floating wind turbine of prior art.

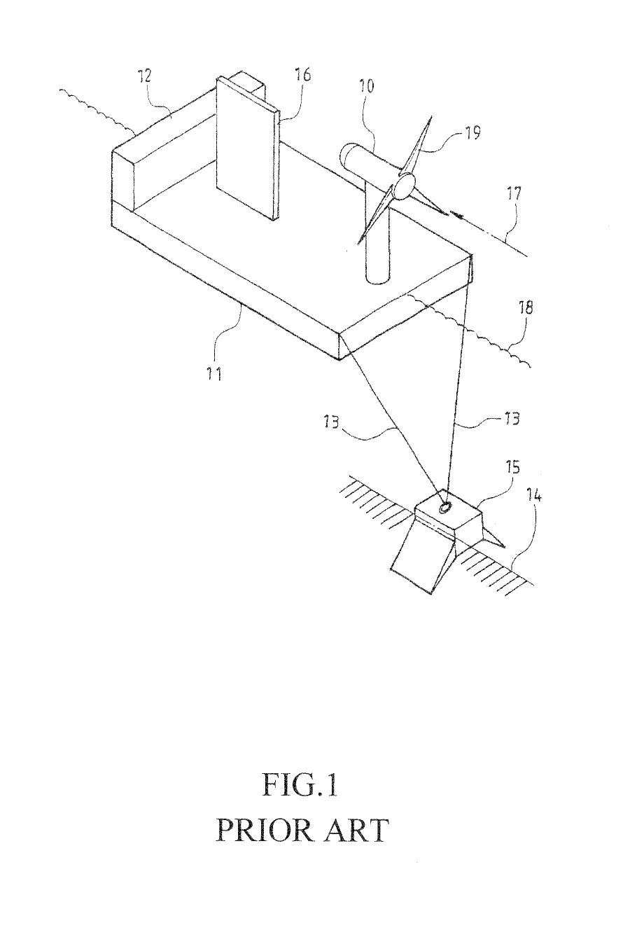

FIG. 2 is a schematic view illustrating a tilted condition of a floating wind turbine of prior art.

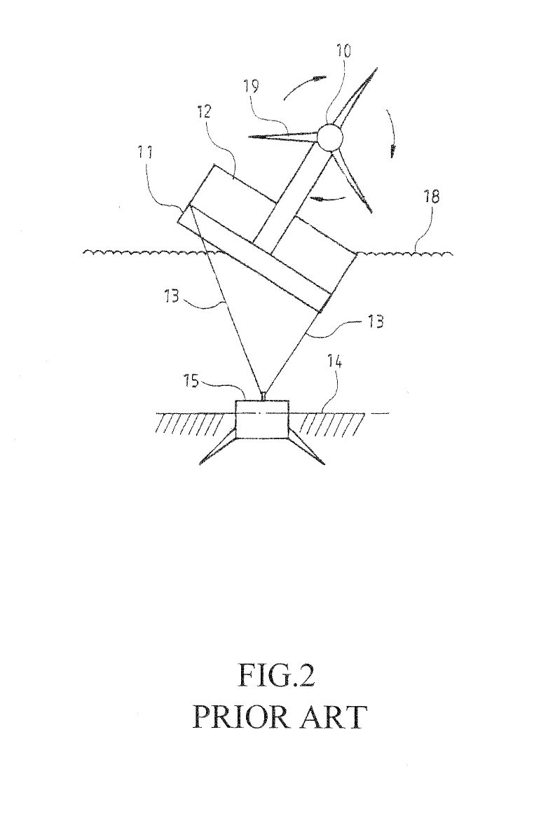

FIG. 3 is a 3-dimensional view showing a construction of the present invention.

FIG. 4 is a front view of the present invention.

### DETAILED DESCRIPTION OF THE PREFERRED EMBODIMENTS

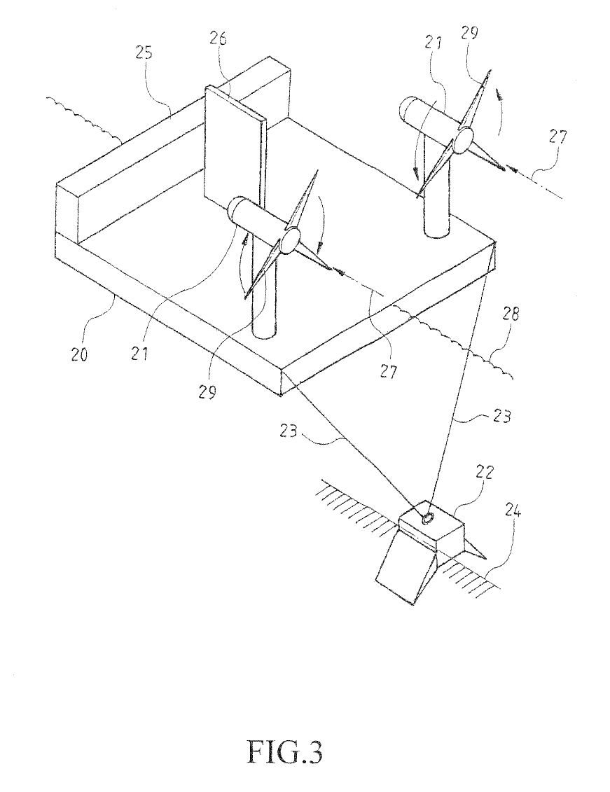

Please refer to FIG. 3, which shows a construction of the present invention. As shown, the present invention comprises a floating foundation 20, two wind turbines 21 mounted on the floating foundation 20, and the anchor 22 on the seabed 24 attached to the floating foundation 20. The floating foundation 20 is installed with two wind turbines 21. In this embodiment, each of the wind turbines 21 can be a horizontal-axis or vertical-axis wind turbine. Alternatively, each of the wind turbines can be an upwind or downwind design, or one of the wind turbines is an upwind design while the other of the wind turbines is a downwind design. The floating foundation 20 is attached to the seabed anchor 22 by one or more tethers 23, in which the seabed anchor 22 is fixed on the seabed 24. The floating foundation 20 is further provided with a ballast 25 for keeping a balance between the front and the rear of the floating foundation 20, and is further provided with a vane 26 instead of a yawing device to enable the floating foundation 20 to drift in the sea 28 along the wind direction 27. In this embodiment, the blades 29 can have a fixed or variable pitch (for variable pitch blade, its angle can be changed via a control).

With a combination of the aforementioned components, the two wind turbines 20 are configured such that one of the two wind turbines has blades rotated in clockwise direction while the other of the two wind turbines has blades rotated in counter-clockwise direction. Since both turbines have an approximately equal speed and output power, the torques existed in the two wind turbines can be naturally counterbalanced or cancelled, whereby the wind turbines 21 and the floating foundation 20 can be maintained at a balanced condition between the left and the right of the floating foundation.

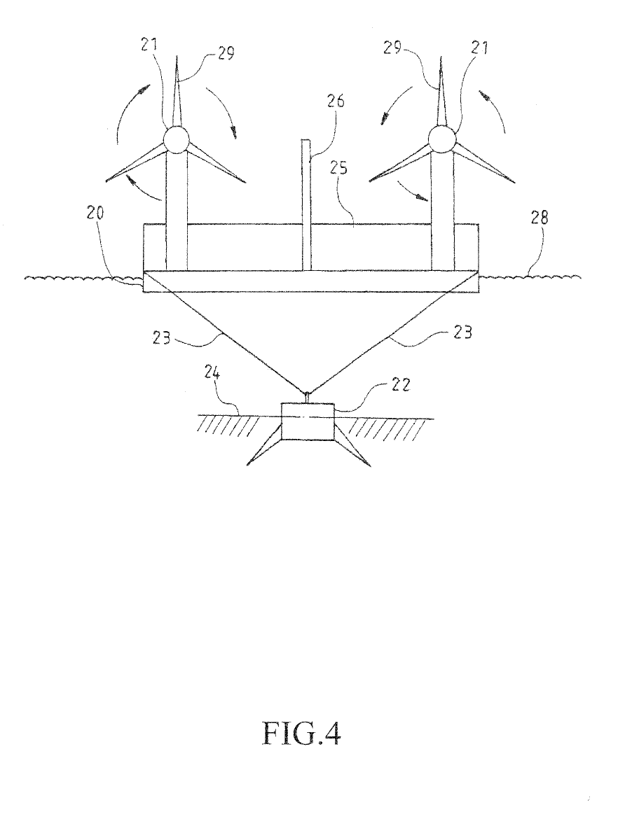

Please refer to FIG. 4, which is a front view of the present invention. As shown, the floating foundation 20 of the present invention is provided with two wind turbines 21. The two wind turbine 21 are configured such that one of the two wind turbines has blades rotated in clockwise direction while the other of the two wind turbines has blades rotated in counter-clockwise direction, opposite to the rotation direction of the former turbine, whereby, due to both turbines having an approximately equal speed and output power, the torques existed in both turbines can be naturally counterbalanced, such that the wind turbines 21 and the floating foundation 20 can be maintained at a balanced condition to prevent them from being tilted or even tumbled.

According to the present invention, an even number and more than two of wind turbines (such as 4, 6, 8, etc.) can be mounted on the floating foundation such that one half of the wind turbines each has blades rotated in clockwise direction while the other half of the wind turbines each rotated in counter-clockwise direction. In such arrangement, torques existed in the wind turbines can be counterbalanced or cancelled in a similar way.

Although the present invention has been described with a certain degree of particularity, it is understood that the present disclosure is made by way of a preferred embodiment only, rather than a limitation of the scope of the invention. Any modifications and changes of parts may be resorted to without departing from the essence and the spirit of the invention.

In light of the foregoing, the present invention provides an even number of wind turbines mounted on a floating foundation, in which one half of the wind turbines each has blades rotated in clockwise direction, the other half of the wind turbines each has blades rotated in counter-clockwise direction. Due to the wind turbines having an approximately equal speed and output power, the torques existed in the wind turbines can be naturally counterbalanced, so that the wind turbines and the floating foundation can be maintained at a balanced condition. It is believed that the present invention is a useful design with novel features. An early and favorable action is respectfully solicited.

I claim:

1. A device of floating wind turbine capable of counterbalancing torques therein, comprising a floating foundation, the wind turbine mounted on said floating foundation, and a seabed anchor attached to said floating station so that said floating foundation can drift in the sea along wind direction to have blades of said wind turbine aligned with wind direction, the device characterized in that:
said floating foundation are provided with two wind turbines so that one of the two wind turbines has blades rotated in clockwise direction, the other of the two wind turbines rotated in counter-clockwise direction, whereby, due to both turbines having an approximately equal speed and output power, said wind turbines and said floating foundation can be maintained at a balanced condition.

2. The device as claimed in claim 1, wherein said two wind turbines are each a horizontal-axis or vertical-axis wind turbine.

3. The device as claimed in claim 1, wherein said two wind turbines are each an upwind or downwind design, or one of said two wind turbines is an upwind design and the other of said two wind turbines is a downwind design.

4. The device as claimed in claim 1, wherein said two wind turbines are each provided with blades of fixed or variable pitch.

5. A device of floating wind turbine capable of counterbalancing torques therein, comprising a floating foundation, the wind turbines mounted on said floating foundation, and a seabed anchor attached to said floating station such that said floating foundation can drift in the sea along wind direction to have blades of said wind turbine aligned with wind direction, the device characterized in that:
said floating foundation are provided with an even number and more than two of wind turbines such that one half of the wind turbine each has blades rotated in clockwise direction, the other half of the wind turbines each has blades rotated in counter-clockwise direction, whereby, due to said wind turbines having an approximately equal speed and output power, said wind turbines and said floating foundation can be maintained at a balanced condition.

6. The device as claimed in claim 5, wherein said wind turbines are each a horizontal-axis or vertical-axis wind turbine.

7. The device as claimed in claim 5, wherein said wind turbines are each an upwind or downwind design, or one half of said wind turbines are each an upwind design and the other half of said wind turbines are each a downwind design.

8. The device as claimed in claim 5, wherein said wind turbines are each provided with blades of fixed or variable pitch.
